(19) United States
(12) Patent Application Publication
(10) Pub. No.: US 2022/0373855 A1
(43) Pub. Date: Nov. 24, 2022

(54) OPTICAL PHASE CONTROL ELEMENTS BASED ON PANCHARATNAM PHASE

(71) Applicants: Kent State University, Kent, OH (US); Government of the United States as Represented by the Secretary of the Air Force, Wright-Patterson AFB, OH (US)

(72) Inventors: Comrun Yousefzadeh, Kent, OH (US); Philip Bos, Hudson, OH (US); Andre Van Rynbach, Dayton, OH (US)

(73) Assignees: Kent State University, Kent, OH (US); Government of the United States as Represented by the Secretary of the Air Force, Wright-Patterson AFB, OH (US)

(21) Appl. No.: 17/651,925

(22) Filed: Feb. 22, 2022

Related U.S. Application Data
(63) Continuation of application No. 16/924,421, filed on Jul. 9, 2020, now abandoned.
(60) Provisional application No. 62/871,852, filed on Jul. 9, 2019.

(51) Int. Cl. G02F 1/29; G01S 7/481; G02B 26/08

(52) U.S. Cl. CPC G02F 1/29; G01S 7/4817; G02B 26/08; G02F 2203/24; G02F 2203/50; G02B 27/283

(57) ABSTRACT

Optical phase control elements are based on the Pancharatnam phase. Tunable liquid crystal devices containing the optical phase control elements may include a liquid crystal cell between a pair of substrates, a first plurality of electrodes, and a second plurality of electrodes. Each individual phase control element is defined by one electrode from the first plurality and one electrode from the second plurality.

This application claims the priority benefit of U.S. Provisional Application No. 62/871,852 filed Jul. 9, 2019 and titled “OPTICAL PHASE CONTROL ELEMENTS BASED ON PANCHARATNAM PHASE,” which is incorporated by reference in its entirety.

### STATEMENT REGARDING FEDERALLY SPONSORED RESEARCH

This invention was made with government support under Grant/Contract No. DEC-J039 awarded by the Air Force Research Laboratory. The government has certain rights in the invention.

### BACKGROUND

The present disclosure relates to the optoelectronic arts, including electrically tunable or adjustable liquid crystal devices, methods of making the same, methods of tuning or adjusting the same, and devices or apparatuses using the same. However, the following will also find application in conjunction with other apparatuses, articles of manufacture, and methods.

There is substantial interest in non-mechanical devices for tunable or adjustable manipulation of light. For example, tunable beam steering devices that can steer a beam of light along different angles or directions responsive to an electrical control input have numerous applications in optics, optical systems, electrooptical systems, and so forth.

A Pancharatnam phase device (PPD) for beam steering has the structure shown in FIG. 1. It includes a thin film of birefringent material, where the phase retardation of the material is ½ wave, and where the optic axis of the film varies along the aperture of the beam steering element. It is shown in the figure that the director (optic axis) is in the plane of the cell and rotated by β(x) across the aperture.

Considering a device with this structure, if it is illuminated with circularly polarized light, the exiting light will be the opposite polarization state. Furthermore, the phase difference between light exiting from two points in the aperture is related to their difference in the value of β with the relation: Γ=2β. Therefore, if the value of β varies linearly across an aperture, the phase profile does as well as shown in FIG. 2.

The phase profile shown is that of a prism and will deflect incident light at an angle given from the relation: sin θ=OPD/Δx=(ΔΓ)/(2πΔx), which can be written as sin θ=(λΔβ)/(πΔx). Furthermore, the efficiency of this type of device can be much greater than that found for conventional diffraction gratings as shown in FIG. 3.

Most devices using the PPD concept for beam steering are either two state or three state devices. There has been at least one report of a tunable device by Shi et al. in U.S. Pat. No. 8,531,646. It is based on controlling the ends of a 180-degree rotation of the director and continuously pulling or pushing the those ends to change the pitch and therefore the beam deflection angle of the device. U.S. Pat. No. 8,531,646 is incorporated by reference herein in its entirety.

There is a need for non-mechanical, electrically controlled devices for steering and focusing light with fast switching time.

### BRIEF DESCRIPTION

Disclosed, in some embodiments, is a tunable liquid crystal device comprising: a cell including a first substrate and a second substrate, wherein the first substrate and the second substrate are parallel and spaced apart to define a cell gap and an aperture; a liquid crystal material disposed in the cell gap; a plurality of first electrodes on or in the first substrate; a plurality of second electrodes on or in the second substrate, each individual second electrode being aligned with an individual first electrode to define a plurality of phase control elements; and a voltage source connected with the electrodes and configured to sequentially activate the first electrodes and the second electrodes in each phase control element to cause a director field between the substrates to be rotated away from a zero-field angle in a with a defined rotational sense, and where subsequently, the same voltage applied to the first and second electrodes in each PCE with a magnitude that adjusts the magnitude of the rotation angle, and therefore the phase of the PCE.

In some embodiments, the first electrodes are activated first to achieve a positive angle of rotation.

The second electrodes may be activated first to achieve a negative angle of rotation.

In some embodiments, at least one of the first and second electrodes is transparent.

At least one of the first and second electrodes may contain indium-tin-oxide.

In some embodiments, the phase control elements are arranged in a two-dimensional array.

Optical beam steering devices, tunable lenses, and light detection and ranging (LIDAR) systems based on the devices are also disclosed. The LIDAR system may be used in an autonomous vehicle.

The sequential activation may include from about 4 to about 20 steps (e.g. about 10 steps).

Disclosed, in other embodiments, is a tunable liquid crystal device comprising: at least one phase control element comprising: a first substrate and a second substrate, wherein the first substrate and the second substrate are parallel and spaced apart to define a cell gap and an aperture; a liquid crystal material disposed in the cell gap; a first electrode on or in the first substrate; and a second electrode on or in the second substrate; and a voltage source connected with the electrodes and configured to sequentially activate the first electrode and the second electrode; wherein the first electrode and the second electrode are rubbed in different directions to allow control of a rotational sense of a director field.

The phase control element may allow for 180° of rotation.

Disclosed, in further embodiments, is a tunable liquid crystal device comprising in sequence: a first common substrate; a first common electrode; a first common insulator; a first plurality of electrodes; a liquid crystal layer; a second plurality of electrodes, each individual electrode in the second plurality of electrodes being aligned with an individual electrode of the first plurality of electrodes; a second common insulator; a second common electrode; and a second common substrate.

Disclosed, in other embodiments, is a process for controlling a director field of a liquid crystal layer wherein the liquid crystal layer is located between a first plurality of electrodes and a second plurality of electrodes, each individual electrode in the first plurality of electrodes being aligned and associated with an individual electrode in the second plurality of electrodes to define a plurality of phase control elements (PCEs), wherein the process comprises: setting a rotation of the director associated with each PCE to have a correct rotational sense; and setting a magnitude of the rotation of the director with each PCE.

In some embodiments, half of the PCEs rotate the director in a positive direction and half of the PCEs rotate the director in a negative direction.

Each individual PCE may exhibit a distinct magnitude of the rotation.

These and other non-limiting characteristics are more particularly described below.

### BRIEF DESCRIPTION OF THE DRAWINGS

The patent or application file contains at least one drawing executed in color. Copies of this patent or patent application publication with color drawings will be provided by Office upon request and payment of the necessary fee. The disclosure can be more fully understood by reading the following detailed description of the embodiment, with reference made to the accompanying drawings as follows.

The following is a brief description of the drawings, which are presented for the purposes of illustrating the exemplary embodiments disclosed herein and not for the purposes of limiting the same.

FIG. 1 includes side and top views of a Pancharatnam phase device (PPD) for beam steering.

FIG. 2 is a graph showing phase profile and β angle as functions of distance across the aperture.

FIG. 3 is a graph showing the efficiency of this type of device.

FIG. 4 is a schematic illustration of a portion of a device in accordance of some embodiments of the present disclosure.

FIG. 5(a)-(d) illustrate a PCE under four different conditions. In FIG. 5(a), the surface boundary condition is set to a value along an axis defined as +ε on one surface. In FIG. 5(b), the surface boundary condition is set to a value along an axis defined as −ε on the other surface. In FIG. 5(c), the effect of the in-plane electric field that is non-zero for the case of a positive material is illustrated. In FIG. 5(d), the effect of a higher field is illustrated.

FIG. 6 is a side view of a device in accordance with some embodiments of the present disclosure.

FIG. 7 illustrates calculated electrical potential in the regions between the substrates.

FIG. 8 illustrates a side view of a non-limiting embodiment of a voltage distribution (FIG. 8, top), a top view of a non-limiting embodiments of a director field (FIG. 8, middle), and the rotation angle of the director field (FIG. 8, bottom).

FIG. 9 is a reflected light microscope image of a device as discussed in the EXAMPLES.

FIG. 10 is a microscope image of a device discussed in the EXAMPLES after being filled with liquid crystal and viewed between polarizers.

FIG. 11 includes microscope images taken with a polarizer on the + surface (left) and − surface (right) as discussed in the EXAMPLES.

FIG. 12 is a graph showing the director angle of each PCE on both surfaces as discussed in the EXAMPLES.

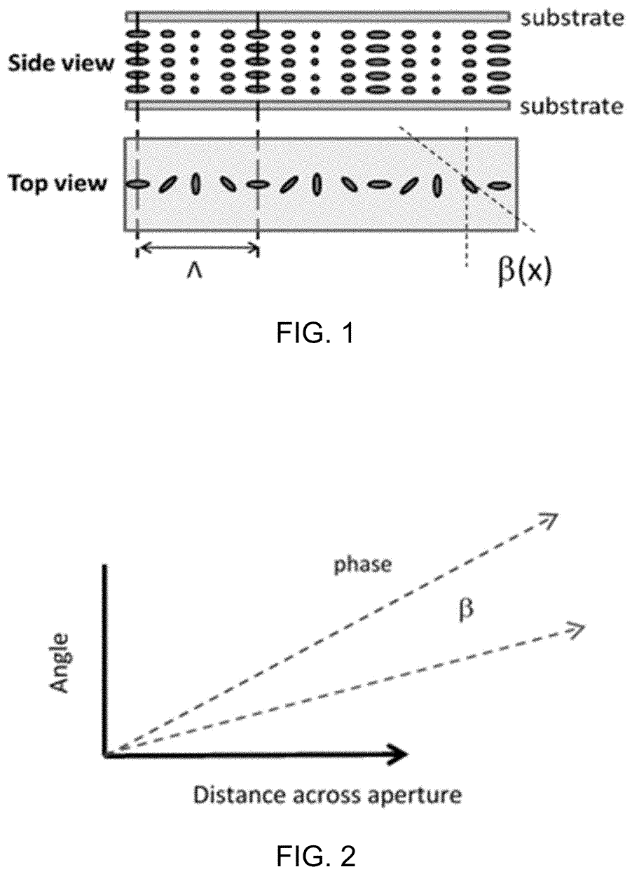

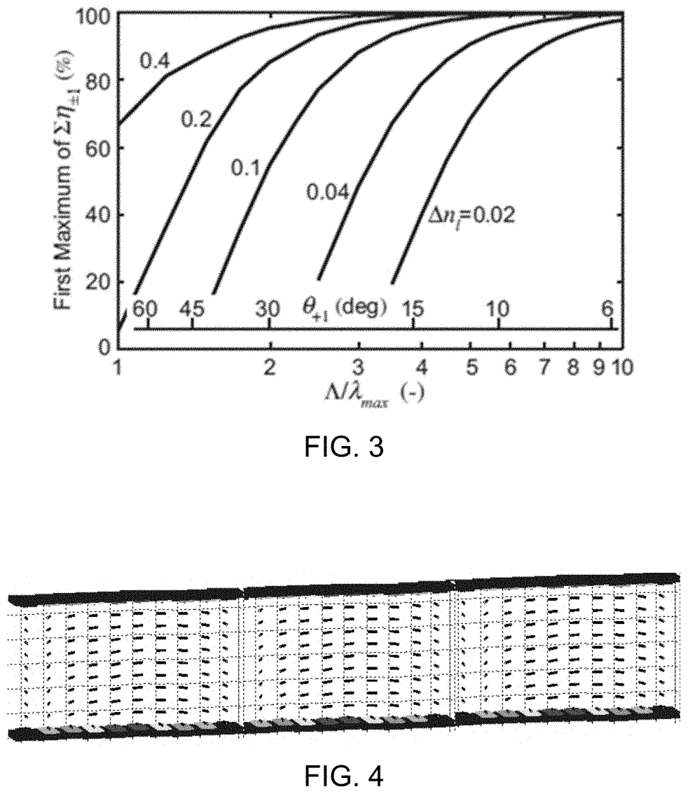

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a non-mechanical, variable, Pancharatnam phase beam steering device. The device may be faster than known devices. The device allows for electrically adjusting the value of the azimuthal angle β(x). The device also reduces or minimizes any efficiency losses resulting from defects in the spiral structure that occur as the pitch of the spiral is changed.

The device includes a plurality of individual phase control elements (PCEs) that allow the sign and magnitude of the director in a local area to be set through the application of an electric field. Each PCE has sub-elements that provide an in-plane electric field that causes the director to rotate away from its zero-voltage value. One aspect relates to creating an in-plane field along both cell substrates to cause the director field between the substrates to be rotated away from its zero-field value to an angle, uniform along the z-direction, whose magnitude is defined by the amplitude of the field. Another aspect is the ability to set the sign (+ or −) of the rotation angle.

The device is capable of providing a 180-degree rotation of the director field, that can be repeated to provide a continuous rotation of the director field over many “cycles”. This can be accomplished in multiple (e.g., two) stages. In a first stage, the sign of the rotation angle (+ or −) can be set. In the second stage, the magnitude of the rotation angle (0-90°) can be set.

FIG. 4 shows a device concept.

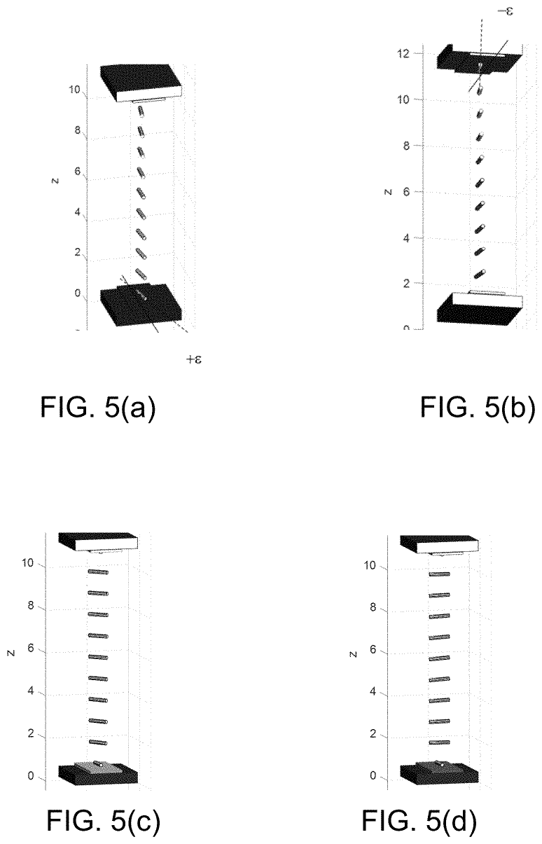

Regarding electrically adjusting the value of β(x), the device has electrical phase control elements (PCE) that can define β(x). The angle β(x) can be set through the balance of torques on the local liquid crystal director field between the surface torque and the electrical torque. One design of a PCE is shown in FIG. 5(a)-(d).

The figure shows that each PCE includes a pair of sub-elements located on two interior surfaces of the device that are capable of providing an in-plane electric field. The surface boundary condition, that defines the director orientation in the absence of the torque supplied by the an in-plane electric field, is set to a value along an axis defined as +ε on one surface (FIG. 5(a)) and −ε on the other (FIG. 5(b)), where the angle is measured from a lab reference axis, here defined an axis that will be called the “symmetry axis”. The other aspect of a PCE is its ability to provide an electric field to provide a torque on the local liquid crystal director axis that is perpendicular to the symmetry axis. Two cases that should be considered are: the case of liquid crystal materials that tend to align parallel to an applied electric field (“positive materials”); and those that tend to align perpendicular to an applied electric field (“negative materials”). For the case of positive materials, the PCE should provide an electric field perpendicular to the symmetry axis, while for the case of negative materials, it should provide a field parallel to the symmetry axis.

The desired characteristic of a PCE is to be able to set the angle β, so any value between −90 and +90 degrees relative to the symmetry axis. The electric field will tend to align the director perpendicular to the symmetry axis, but without intrinsic bias for the sign of the angle. In this embodiment, the sign of the angle of rotation of the director away from the symmetry axis is determined by the order of application of the electric field generated by the two sub-elements of a PCE. If it is desired to have a positive angle of rotation, the sub-element with the positive bias of the angle ε is activated first. The magnitude of the field from the selected sub-element is caused to be great enough to shift the director at the opposite sub-element to be in the positive direction. Then that sub-element is activated causing the director field between the sub elements of the PCE to uniformly rotate to the positive direction. On the other hand, if the sub-element that has a negative value of ε is activated first, this process causes the director field of the PCE to rotate in the negative direction. Further, the magnitude of the rotation angle is defined by the balance of torques between the electric torque and the surface anchoring torque. Therefore, by controlling the magnitude of the electric field generated by the PCE, the desired magnitude of the rotation angle can be achieved. FIG. 5(c) shows the effect of the in-plane electric field that is non-zero for the case of a positive material, and FIG. 5(d) shows a higher field. In both of these cases, the lower electrode was activated before the top one as explained above.

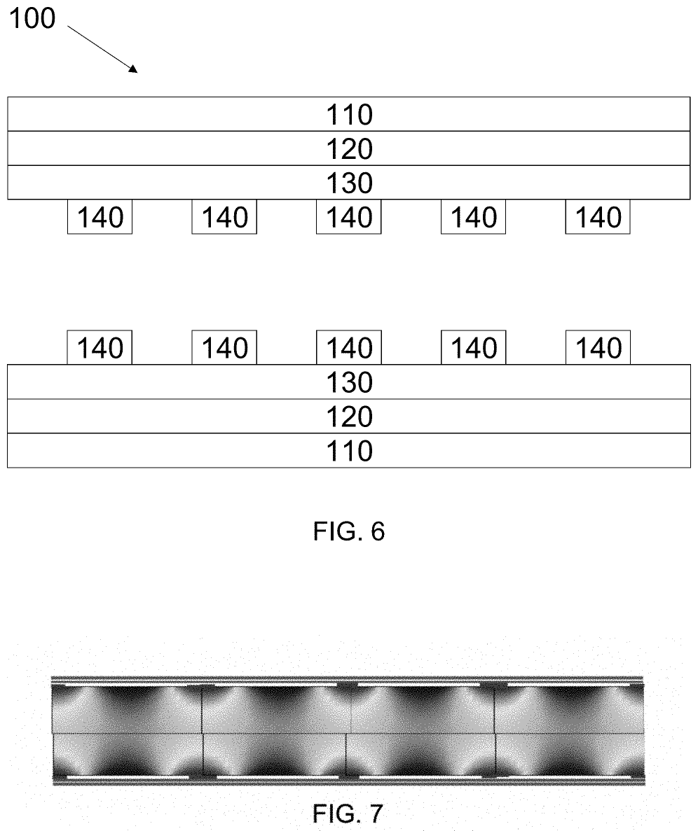

In some embodiments, the in-plane electric field of (e.g., five) PCE's on each surface is applied by the electrode structure shown in FIG. 6. The structure may be referred to as a “FFS” (or fringe field switching) structure. Shown is a thin film structure deposited on the glass surfaces that includes four layers. Going from the glass to the LC, the layers are: the common electrode; an insulator; the drive electrode; and the LC alignment layer. Typical thicknesses of the glass substrate are 100s of microns, and the other layers are from 10s to 100s of nanometers. The gap between the substrates that contains the LC is a few microns. The electrodes are typically transparent ITO; the insulator is SiO₂ and the alignment layer is a commercial polyimide or photo-alignment type alignment layer.

FIG. 6 shows a side view of the proposed device 100 showing: the glass substrates 110; the common electrode 120; the insulator 130 and the individually addressable electrodes of five PCE's 140.

FIG. 7 shows the calculated electric potential in the regions between the substrates. The blue color is the potential of the common electrode and the red color represents the potential of the PSE electrodes from several PCE's that are here shown to be all at the same potential.

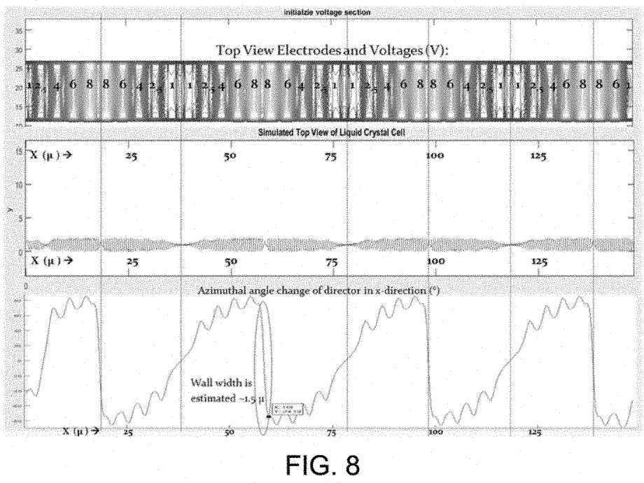

FIG. 8, top shows a side view of a nonlimiting example of a proposed device that here has many PCE's whose voltages are shown by the numbers. FIG. 8, middle is a top view of the director field in-plane parallel to the substrates, whose location is midway between the substrates for the case of the voltages applied in FIG. 8, top. The voltages are not optimized here, but the basic device principle is shown here: that the in-plane director profile can be controlled. FIG. 8, bottom shows the rotation angle of the director field shown in FIG. 8, middle.

Advantageously, the devices of the present disclosure may exhibit reduced time to change optical states in comparison to other high-performance devices.

The control elements of the present disclosure may be useful in high performance optical phase control devices, liquid crystal optical beam steering devices, and/or liquid crystal-based optical lenses.

Non-limiting examples of applications include optical beam steering, tunable lenses, arbitrary optical wavefront control, and Light Detection and Ranging (LIDAR) applications (e.g., for autonomous vehicles).

In some embodiments, each phase control element includes two driven electrodes: one on each of two opposing surfaces. To establish a 180 degree director profile repeated over the aperture, a select voltage may be applied to half the electrodes on the first surface in a first area of the aperture and to half of the electrodes on the second surface in a second area of the aperture that is non-overlapping and adjacent to the first area. This may, in effect, cause there to be a “trapped wall” over the gap between the two adjacent areas.

Another possible voltage application scheme, where N is the number of electrodes over which the director rotates by 180 degrees, includes applying a select voltages to N/2−1 electrodes on the first surface and N/2−1 electrodes on the second surface over second areas that are non-overlapping with the first areas. There is one PCE between the two areas that have electrodes selected on either the first or second surface. This unique PCI in each region of 180 twist has a common voltage applied to both of its electrodes (on the first and second substrate). This, in effect, causes there to be a “trapped wall” over the electrodes of the unique PCE that separates the two areas.

These electrodes may be connected to the same or different power sources. In some embodiments, each PCE is connected to a different power source. In other embodiment, a plurality or even all of the PCEs may be connected to the same power source. In some embodiments, at least one power source supplies power to electrodes on one surface and at least one power source supplies power to electrodes on the opposing surface.

The following examples are provided to illustrate the devices and methods of the present disclosure. The examples are merely illustrative and are not intended to limit the disclosure to the materials, conditions, or process parameters set forth therein.

### EXAMPLES

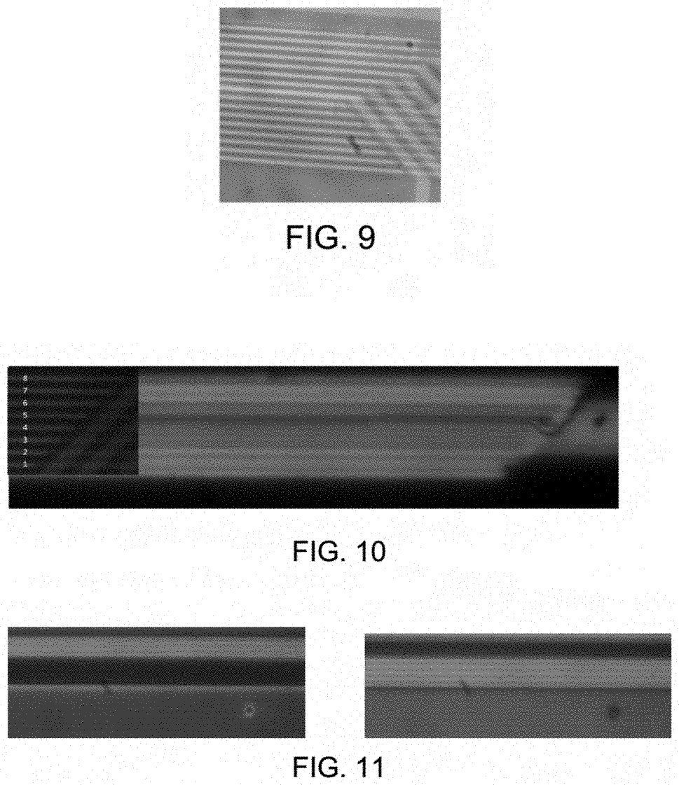

To test calculations, a device was fabricated following the design of FIG. 6. The PCE electrodes are 1.5 microns wide, and are on 4-micron centers, and made of ITO. The substrates are spaced apart by 3 microns. FIG. 9 shows a reflected light microscope image of a section of the device (16 PCEs) after the substrates were assembled, but before the liquid crystal was filled into the cell. In this case, the transparent ITO electrodes are visible in reflected light.

In the picture each bright line is actually the reflection from the two electrodes, one on each surface, that make up a PCE.

To test basic device operation, a 180-degree rotation of the director field was demonstrated. If this is shown, the director configuration of FIG. 8 will be able to be formed by repeating the method to achieve a 180-degree rotation of the director three and a half times. This can be achieved, by controlling 8 PCEs (8 of the 16 shown in FIG. 9).

The process of setting the correct director configuration has two stages. The first stage is to set the rotation of the director associated with each PCE to have the correct rotational sense (+ or −), and the second stage is to further adjust the voltage on each PCE to have the correct magnitude of the angle (0 to 90 degrees)

For the first stage in this example, it can be seen in FIG. 8, 1 cycle of the director rotation is shown where half of the PCEs need to rotate the director in the positive direction, and half in the negative direction. And the magnitude of the rotation angle is distinct for each PCE. For clarity, it is shown how the device can set the correct rotational sense of a series of adjacent PCE's to be positive for half of the considered PCE's in 1 cycle, and negative for the other half. To achieve this, the following 10 step process was used. The columns are the electrodes of the PCEs (+ is the electrodes on the + substrate and − are the electrodes on the − substrate) and the rows are the voltages applied to the shown electrodes in each sequential step.

Referring to the Table 1 below, in this method, electrodes +1 to +4 are activated into a positive rotation direction. Then, electrodes −1 to −4 are activated to follow the positive direction from previous states. Then, the voltage on the side with + pretilt (+1 to +4) is lowered to reduce the elastic force effect onto the neighbor side. Then, the electrodes −7 and −8 are activated to get them into negative rotation direction followed by activating electrodes +7 and +8. After this “separated” areas into different twist states are obtained, and electrodes −6 and +6 are activated and finally −5 and +5 respectively. While this many steps may not be required, this method provides a more robust method to provide the desired rotation directions.

TABLE 1

| V | Electrode | Electrode | Electrode | Electrode | Electrodes | Electrode | Electrodes | Electrode |
|---|---|---|---|---|---|---|---|---|
| Steps | (+1 to +4) | (−1 to −4) | (−5) | (+5) | (−6) | (+6) | (−7 & −8) | (+7 & +8) |
| 1 | 6 | 0 | 0 | 0 | 0 | 0 | 0 | 0 |
| 2 | 3 | 3 | 0 | 0 | 0 | 0 | 0 | 0 |
| 3 | 3 | 3 | 0 | 0 | 0 | 0 | 6 | 0 |
| 4 | 3 | 3 | 0 | 0 | 0 | 0 | 6 | 6 |
| 5 | 3 | 3 | 0 | 0 | 6 | 0 | 6 | 6 |
| 7 | 3 | 3 | 0 | 0 | 6 | 6 | 6 | 6 |
| 8 | 3 | 3 | 6 | 0 | 6 | 6 | 6 | 6 |
| 9 | 3 | 3 | 6 | 6 | 6 | 6 | 6 | 6 |
| 10 | 6 | 6 | 6 | 6 | 6 | 6 | 6 | 6 |

As a check of the success of the stage, the director orientation of a PCE can be determined by the following method: When the polarizers are aligned so that one is parallel to the director near one substrate, and the other is crossed to the director orientation near the other substrate: the image should appear black. So, by finding the angles of the two polarizers that make a PCE black, the angle of its director rotation can be determined. FIG. 10 shows the device of FIG. 9, after being filled with LC and viewed between polarizers. In FIG. 10, PCE 5 is black. From the angle of the two polarizers required to achieve this, the director angle for PCE 5 can be ascertained.

FIG. 11 demonstrates the successful result of this voltage sequence for the first stage. The microscope pictures are taken of the cell between crossed rotated polarizer. The device shown is the same one as FIG. 9, but now filled with liquid crystal. In FIG. 10 the picture on the left is taken with the polarizer on the + surface oriented at +75 degrees, and the polarizer near the − surface is at +72 degrees. This indicates that the liquid crystal contained in the lower PCEs is rotated by about +73 degrees. The picture on the right is taken with the polarizer on the + surface oriented at −70 degrees, and the polarizer near the − surface is a −66 degrees. This indicates that the liquid crystal contained in the upper PCEs is rotated by about −68 degrees.

In the second stage, after achieving the desired rotation direction of all 8 considered PCEs. The voltages are adjusted to change the magnitude of the rotation angle of the PCEs. It is desired in this example to cause the director field to approximate a 180-degree rotation across the 8 electrodes.

The voltages then applied to both electrodes of each of the 8 PCEs are given in Table 2 below.

TABLE 2

| | Electrode | | | | | | | |
|---|---|---|---|---|---|---|---|---|
| | 1 | 2 | 3 | 4 | 5 | 6 | 7 | 8 |
| Voltage(V) | 2.5 | 3.5 | 5 | 8 | 8 | 5 | 3.5 | 2.5 |

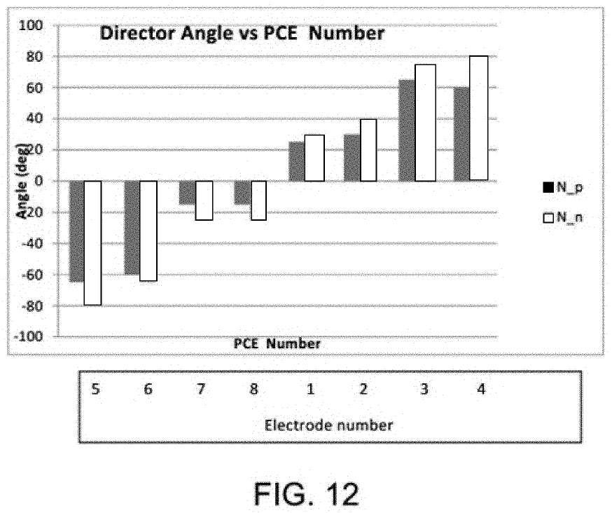

By using the method seen in FIG. 10 the polarizers were adjusted to find the director angle for each of the 8 PCEs. The results are shown in FIG. 12.

In FIG. 12, the director angles of each PCE on both surfaces are shown. It can be seen the result of the two-stage process was to cause the desired director configuration to be formed.

As can be seen in the 1 cycle of the director rotation in FIG. 12, half of the PCEs are rotated in the positive direction and half in the negative direction. To achieve this, the 10 step method described in Table 1 was used where the columns are the electrodes of the PCEs (+ is the electrodes on the + substrate and − are the electrodes on the − substrate) and the rows are the voltages applied to the shown electrodes in each sequential step. Subsequent to the method to set the director rotation direction in each PCE, the voltages of Table 2 were applied.

These results show the first successful reduction to practice of the concept of the device. With this data, it is established that an array of PCEs can be made and the sign and magnitude of the director in each one can be controlled.

This result clears the way for the subsequent device optimization effort to achieve a tunable Pancharatnam based tunable beam steering device relatively short term. Although the Examples relate to one row of PCEs, the present disclosure also expressly contemplates the use of two-dimensional arrays of PCEs to make a two-dimensional electrically controllable phased array.

Embodiments are also envisioned where the rub direction along is symmetry axis on both surfaces but have electric field on the two surfaces being slightly off from parallel so that get desired sign of angle by which sub element is turned on first. Here, the twist angle relative to the electrodes is of the opposite sign on opposite substrates. This could be achieved by having the electrode direction the same on both surfaces and having the alignment angles differ or by having the alignment angles be the same on both surfaces but having the electrode angles be different.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1-20. (canceled)

21. A tunable liquid crystal device comprising:
at least one Pancharatnam phase control element comprising:
a first substrate and a second substrate, wherein the first substrate and the second substrate are parallel and spaced apart to define a cell gap and an aperture;
a liquid crystal material disposed in the cell gap;
a first electrode on or in the first substrate; and
a second electrode on or in the second substrate; and
a voltage source connected with and configured to sequentially activate the first electrode and the second electrode;
wherein a first alignment layer associated with the first electrode and a second alignment layer associated with the second electrode are rubbed in different directions to allow control of rotation of a director about an axis extending between and perpendicular to the first substrate and the second substrate; and
wherein the liquid crystal alignment in each phase control element is:
substantially uniform through the thickness of the device between the two substrates; and
substantially parallel to the plane of the substrates and rotated to a common angle β about an axis perpendicular to the substrates.

22. The tunable liquid crystal device of claim 21, wherein the Pancharatnam phase control element is configured to transmitted circularly polarized light to be electrically set to an arbitrary value of the range of 2 pi radians.

23. The tunable liquid crystal device of claim 21, wherein the liquid crystal director angle β of a phase control element can be electrically controlled to be varied over a range of 180 degrees to cause an optical shift of transmitted circularly polarized light to be controlled to be between 0 and 2 pi radians.

24. A process for controlling the phase shift of a phase control element by controlling an angle β of the liquid crystal layer in the phase control element; wherein the liquid crystal layer is located between a first plurality of electrodes and a second plurality of electrodes, each individual electrode in the first plurality of electrodes being aligned and associated with an individual electrode in the second plurality of electrodes to define a plurality of phase control elements (PCEs), wherein the process comprises:
setting a direction of rotation of β for each PCE; and
setting a magnitude of β for each PCE.

25. The process of claim 24, wherein either:
the direction of rotation of β is set in a first step of a two-step sequence by applying voltage to electrodes of a particular phase control elements that are associated with a first substrate; and a director surface alignment angle c is rotated in the positive direction if the direction of rotation of β is desired to be of the positive sense; or
the direction of rotation of β is set in the first step by applying voltage to electrodes of the particular phase control elements associated with a second substrate; and a director surface alignment angle ε is rotated in the negative direction if the direction of rotation of β is desired to be of the negative sense.

26. The process of claim 24, wherein the magnitude of the angle β is set in the second step of a sequence of two steps by applying the same voltage to the electrodes on both substrates associated with a particular phase control element; and wherein the magnitude of the voltage is related to the magnitude of the angle β.

27. The process of claim 24, wherein the angle β associated with a first near half of the PCEs is positive and the angle β associated with a second near half of the PCEs is negative.

28. The process of claim 24, wherein at least one of the first and second pluralities of electrodes comprises indium-tin-oxide.

29. The process of claim 24, wherein the phase control elements are arranged in a two-dimensional array.

30. The process of claim 24, wherein the first plurality of electrodes and the second plurality of electrodes are connected to a common power source.

31. The process of claim 24, wherein the first plurality of electrodes and the second plurality of electrodes are connected to different power sources.

32. The process of claim 24, wherein the direction and the magnitude are set by sequentially activating the first plurality of electrodes and the second plurality of electrodes.

33. The process of claim 24, wherein the direction is set before the magnitude is set.

34. The process of claim 24, wherein a select voltage is applied to the first plurality of electrodes in a first region of PCEs; wherein the select voltage is applied to the second plurality of electrodes in in a second region of PCEs separated from the first region of PCEs by a single PCE; and wherein a common voltage is applied to a first individual electrode and a second individual electrode of the single PCE.

35. The process of claim 24, wherein a select voltage is applied to the first plurality of electrodes in a first half of the PCEs and to the second plurality of electrodes in a second half of the PCEs which are non-overlapping with the first half of the PCEs.

36. A process for controlling a director field of a liquid crystal layer located between a first plurality of electrodes and a second plurality of electrodes, each individual electrode in the first plurality of electrodes being aligned and associated with an individual electrode in the second plurality of electrodes to define a plurality of phase control elements (PCEs), wherein the process comprises:
setting a direction of rotation, about an axis extending between and perpendicular to the first substrate and the second substrate, of a director associated with each PCE; and
setting a magnitude of the rotation, about the axis extending between and perpendicular to the first substrate and the second substrate, of the director associated with each PCE;
wherein the plurality of PCEs comprises a first set of PCEs in a first region and a second set of PCEs in a second region separated from the first region;
wherein the director field comprises a first director profile in the first region and a second director profile in the second region; and
wherein the first director profile and the second director profile are the same.

37. The process of claim 36, wherein the first director profile comprises a first director profile first end director in a first end PCE and a first director profile second end director in a second end PCE; and wherein the first director profile first end director is rotated 180° relative to the first director profile second end director.

38. The process of claim 36, wherein the phase control elements are arranged in a one-dimensional array or a two-dimensional array.

39. The process of claim 36, wherein at least one of the first plurality of electrodes and the second plurality of electrodes comprises indium tin oxide.

40. The process of claim 36, wherein the director associated with each PCE exhibits a distinct magnitude of rotation relative to the other PCEs.
